(19) United States
(12) Patent Application Publication
(10) Pub. No.: US 2002/0120059 A1
(43) Pub. Date: Aug. 29, 2002

(54) Method of preparing a lacquer composition

(76) Inventors: Ytsen Wielstra, Drachten (NL); Jolanda Harma Sagitta Winkel, Drachten (NL)

Correspondence Address: U.S. Philips Corporation, 580 White Plains Road, Tarrytown, NY, 10591, US

(21) Appl. No.: 10/047,024

(22) Filed: Jan. 15, 2002

(30) Foreign Application Priority Data
Jan. 18, 2001 (EP) 01200191.3

(51) Int. Cl. C08J 3/00

(52) U.S. Cl. 524/588

(57) ABSTRACT

Disclosed is a method of preparing a lacquer composition, said method comprising the steps of mixing together an organosilane compound and silica particles under basic conditions. A metal alkoxide is added to the reaction mixture in order to prevent premature gelation of the reaction mixture. A lacquer composition which is obtainable by the above method is also disclosed, as well as a method of applying a lacquer coating to a substrate and the coated substrate obtained.

The present invention relates to a method of preparing a lacquer composition, said method comprising the steps of mixing together an organosilane compound and silica particles under basic conditions. The invention also relates to a lacquer composition which is obtainable by the method according to the invention, as well as to a method of applying a lacquer coating to a substrate.

The lacquer compositions of the above mentioned type, also referred to as solgel materials, are usually made by hydrolysis of silanes forming Si—OH groups, which are coupled towards Si—O—Si bonds upon curing. Silanes can be hydrolyzed both in an acidic environment as well as in a basic environment. However, the behavior of the Si—OH groups in an acidic environment differs from the behavior of said groups in a basic environment. The different behavior of the Si—OH groups in basic and acidic conditions is, inter alia, disclosed in “Sol-Gel Science; The Physics and Chemistry of Sol-Gel Processing”, chapter 2, by C.,J. Brinker and G. W Scherer.

Under acidic conditions, coupling of the Si—OH groups is relatively slow. This slow coupling results in a positive effect on the potlife of a lacquer made under the same conditions. Upon curing of the material, a forced coupling takes place forming chain-like structures which resemble normal organic polymers.

However, under basic conditions, coupling of the Si—OH groups is relatively fast, due to the high reactivity of the Si—OH groups. As a consequence of said fast coupling of Si—OH groups particles of nanometer size are formed, instead of chain-like structures. This process is hard to control and can result in flocculation and gelation. Upon curing of the coating the layers turn white.

The present invention aims to provide for a method of preparing a lacquer composition under basic conditions, which method provides for a controlled coupling of Si—OH groups and which method prevents premature gelation.

To this end, the present invention provides for a method according to the preamble, which method is characterized in that a metal alkoxide is added to the reaction mixture.

By adding a metal alkoxide to the basic reaction mixture the coupling reaction can be suppressed. As the metal complex reacts with SiOH forming metal-OSi bonds an uncontrolled growth is prevented. An important advantage of the method according to the present invention is that new materials can be made with different properties.

The basic conditions under which the lacquer composition is prepared, are preferably caused by the addition of ammonia to the reaction mixture.

The benefit of the method according to the present invention especially applies for lacquer compositions to which silica particles are added in order to provide for increased strength and reduced shrinkage. As the iso-electric point of silica is 2, and therefore the silica particles are electrically neutral at pH 2, a poor stabilization of silica particles is obtained at said pH. Under more basic conditions the particles are negatively charged resulting in improved stability and reduced tendency towards flocculation. Therefore, upon curing of such basic lacquer improved packing of the particles is obtained with better properties of the final coating.

The metal alkoxide preferably comprises a zirconium alkoxide or an aluminum alkoxide or a mixture thereof. Also titanium alkoxide can be used.

Preferably, the metal alkoxide comprises a diketonate, such as metal ethylacetoacetate or a metal acetylacetone or a mixture thereof.

Although the organosilane compound may comprise different reactive groups, it is preferred to use an epoxysilane, preferably 3-glycidyloxypropyltrimethoxysilane (GLYMO).

In order to influence the properties of the network of the cured lacquer coating, advantageously at least a second organosilane compound is present.

In particular the mechanical strength of the cured lacquer layer can be improved by using a tetra-alkoxysilane, such as tetra-alkylorthosilicate (TEOS) or tetramethylorthosilicate (TMOS).

The properties of the lacquer composition can further be improved by the addition of organic compounds, such as epoxides and polyalcohols or by the addition of inorganic materials, such as metaloxides, like aluminumoxide or titaniumoxide.

The present invention further relates to a lacquer composition which is obtainable by the method according to the present invention as disclosed in the above.

Said lacquer composition has excellent film-forming properties. Moreover, the lacquer composition may be sprayed on the substrate to form a lacquer coating, if necessary by adding a diluting agent. The lacquer coating which is obtained by curing the lacquer composition according to the present invention is transparent and meets high quality standards from an optical and an esthetical point of view. Moreover, the lacquer coating proves to be wear-resistant and scratch-resistant, even after prolonged exposure to solvents or compositions for personal care, such as shaving lotions. This makes the application of the lacquer useful in electric shavers, such as the shaver head or a housing.

Furthermore, the present invention relates to a method of applying a lacquer coating to a substrate in which method a lacquer composition is applied to the substrate and cured, thereby forming the lacquer coating. Said method is characterized in that a lacquer composition according to the present invention is used. The lacquer composition can be provided by means of methods known per se, such as spraying, spin-coating, curtain-coating or dip-coating. The lacquer composition can be cured by means of heating. The appropriate temperature and the duration of the thermal treatment are governed by the lacquer composition used and can be determined in a manner known to the skilled person, for example by measuring the hardness of the lacquer coating.

Finally, the invention relates to a product which is provided with a lacquer coating, said product being characterized in that the lacquer coating is obtained by using the method of applying a lacquer coating to a substrate according to the present invention.

The lacquer composition according to the invention can be applied to a great variety of products. The lacquer can have both the function of a protective coating as well as improving the attractive properties of the product provided with the lacquer. Examples of products which may be provided with the lacquer are housings for electr(on)ical products, such as television receivers, personal digital assistants, mobile phones, and personal computers; personal-care products, such as shavers; domestic appliances, such as irons, and luminaires; vehicle parts, such as doorhandles and roofbars for cars, bicycle parts, and boat parts.

The invention will be further elucidated by means of the following examples.

### EXAMPLES 1-3

### Preparation of the Metal Alkoxides

### Example 1

A quantity of 17.4 g ethylacetoacetate was added to 63 g Zr(OC₃H₇)₄ (70% in propanol) at room temperature and the solution was stirred. The resulting solution in which ethylacetoacetate has bonded to the zirconium is called zirconium ethylacetoacetate (ZrEAA). When the amount of ethylacetoacetate was doubled Zr(EAA)₂ was formed.

### Example 2

A quantity of 13.4 g acetyleacetone was added to 63 g Zr(OC₃H₇)₄ (70% in propanol) at room temperature and the solution was stirred. Zirconium acetylacetone (Zr(AcAc)) was formed. When the amount of acetylacetone was doubled Zr(AcAc)₂ was formed.

### Example 3

A quantity of 40 g Al(OC₄H₉)₃ was added to 21 g ethylacetoacetate at room temperature and the solution was stirred. This resulted in the formation of a solution of aluminum ethylacetoacetate (AIEAA).

### Examples 4-9

### Preparation of the Lacquer Compositions

### Example 4

Half of a mixture of 19.6 g glycidyloxypropyltrimethoxysilane (GLYMO), 8.6 g tetra-ethylorthosilicate (TEOS) and 30 g alcohol was added to 44 g of an aqueous suspension of silica particles (Ludox AS40, Dupont de Nemours), while the solution was stirred. After 2 minutes the other half of the mixture was added. After stirring during 7 minutes, 7.8 g AlEAA, prepared according to the method as disclosed in example 3, was added. Subsequently, 1.4 g ammonia (25%) was added to the solution. The pH was measured to be 7.36.

The mixture was observed for hydrolysis of the silanes. Hydrolysis is said to be complete when the composition gives proper wetting on a glass substrate.

After 4 days hydrolysis of the silanes was not completed yet.

### Example 5

Half of a mixture of 19.6 g GLYMO, 8.6 g TEOS and 30 g alcohol was added to 44 g Ludox AS40, while the solution was stirred. After 2 minutes the other half of the mixture was added. After stirring during 7 minutes, 7.8 g AlEAA, prepared according to the method as disclosed in example 3, was added. Subsequently, 2.8 g ammonia (25%) was added to the solution. The pH was measured to be 9.5.

Hydrolysis of the silanes was completed within 4 hours. After curing of the lacquer a transparent wear-resistant layer was obtained.

### Example 6

Half of a mixture of 23.7 g GLYMO, 5.2 g TEOS and 30 g alcohol was added to 44 g Ludox AS40, while the solution was stirred. After 2 minutes the other half of the mixture was added. After stirring during 7 minutes, 11.8 g ZrAcAc, prepared according to the method as disclosed in example 2, was added. Subsequently, 1.4 g ammonia (25%) was added to the solution. The pH was measured to be 9.0.

Hydrolysis of the silanes was completed within 4 hours. After curing of the lacquer a transparent wear-resistant layer was obtained.

### Example 7

Half of a mixture of 19.6 g GLYMO, 8.6 g TEOS and 30 g alcohol was added to 44 g Ludox AS40, while the solution was stirred. After 2 minutes the other half of the mixture was added. After stirring during 7 minutes, a mixture of 9.3 g ZrEAA and 3.9 g AlEAA, prepared according to the methods as disclosed in example 1 and 3 respectively, was added. Subsequently, 2.8 g ammonia (25%) was added to the solution. The pH was measured to be 10.0.

Hydrolysis of the silanes was completed within 1 hour. After curing of the lacquer a transparent wear-resistant layer was obtained.

### Example 8

A mixture of 19.6 g GLYMO and 30 g ethanol was added to 44 g Ludox AS40 while the solution was stirred. After 2 minutes 6.3 g tetra-methyl orthosilicate (TMOS) was added. After stirring during 7 minutes, a mixture of 9.3 g ZrEAA and 3.9 g AlEAA was added. The pH was measured to be 7.8.

Hydrolysis of the silanes was complete after 15 minutes. After curing of the lacquer a transparent and wear-resistent layer was obtained.

### Example 9

### Comparative Example

Half of a mixture of 19.6 g GLYMO, 8.6 g TEOS and 30 g alcohol was added to 44 g Ludox AS40, while the solution was stirred. After 2 minutes the other half of the mixture was added. Subsequently, 2.8 g ammonia (25%) was added to the solution. The pH was measured to be 10.5.

Hydrolysis of the silanes was completed within 1 hour. After curing of the lacquer a cloudy, brittle layer was obtained.

### Example 10

### Testing of the Lacquer, Obtained by Applying the Compositions of Examples 5-8 on a Substrate and Curing Said Lacquer Compositions

A quantity of 3 g aluminum pigment (E2140 of Silberline) was added to each of the lacquer compositions prepared according to examples 5, 6, 7 and 9, respectively, and dispersed under stirring. The lacquer compositions obtained were sprayed on a substrate of IXEF 1032 (Solvay polyarylamide 60%GF), resulting in a metallic appearance of the substrate. Thereupon, the coatings were cured at 160° C. during 20 minutes. A coating thickness of 20 micron was obtained.

The chemical resistances of the lacquers were tested by immersing the coated substrate in commercial shaving lotions during 28 days. The lacquer coatings passed said test without being attacked of softened.

The mechanical resistances of the lacquers were tested by bringing the lacquer coatings into contact with a rotating disc-shaped abrasive sponge (Scotch Brite), with a compressive force of 500 g during 20 minutes. After said treatment, no signs of wear were observed.

1. A lacquer composition, obtainable by a method comprising the steps of mixing together an organosilane compound and silica particles under basic conditions, characterized in that a metal alkoxide is added to the reaction mixture.

2. A lacquer composition according according to claim 1, characterized in that the metal alkoxide is a zirconium alkoxide, an aluminum alkoxide, a titanium alkoxide or a mixture thereof.

3. A lacquer composition according to claim 1 or 2, characterized in that the metal alkoxide comprises a metal diketonate.

4. A lacquer composition according to claim 1, characterized in that the organosilane compound is an epoxysilane.

5. A lacquer composition according to claim 4, characterized in that the epoxysilane is 3-glycidyloxypropyltrimethoxysilane.

6. A lacquer composition according to claim 1, characterized in that at least a second organosilane compound is present.

7. A lacquer composition according to claim 6, characterized in that the second organosilane compound comprises a tetra-alkoxysilane.

8. A method of applying a lacquer coating to a substrate in which method a lacquer composition is applied to the substrate and cured, thereby forming the lacquer coating, characterized in that a lacquer composition as claimed in claims 1-7 is used.

9. Product provided with a lacquer coating, characterized in that the lacquer coating is obtained by using the method as claimed in claim 8.

10. A starting material composition for obtaining a lacquer composition as claimed in any of the claims 1-7, compromising an organosilane compound, silica particles, a base, and a metal alkoxide.
